(19) United States
(12) Patent Application Publication
(10) Pub. No.: US 2013/0110718 A1
(43) Pub. Date: May 2, 2013

(54) VIRTUAL MONEY SYSTEM

(71) Applicant: Jasim Saleh Al-Azzawi, Dubai (AE)

(72) Inventor: Jasim Saleh Al-Azzawi, Dubai (AE)

(21) Appl. No.: 13/670,256

(22) Filed: Nov. 6, 2012

(51) Int. Cl. G06Q 40/02; G06Q 20/10

(52) U.S. Cl. 705/43; 705/42

(57) ABSTRACT

A DMC system integrates computerized systems, data storage systems, ATM machines, DMC machines and mobile phone systems capable of creating, selling and executing Digital Money Codes transactions to empower individuals to convert their cash into Digital Money Codes and to convert purchased Digital Money Codes to cash at different locations and empower people to send purchased Digital Money Codes to anywhere in the world so that they can convert the transmitted Digital Money Codes to cash at any time they want.

### BACKGROUND OF THE INVENTION

Millions of people worldwide have no credit cards or bank accounts and consequently are unable to transfer and receive funds or purchase products and services from the Internet. People living in remote villages, small cities or underdeveloped countries, where there are no money transfer financial institutions such as Western Union, cannot transfer or receive funds from relatives and friends. People, who want to wire small amounts of money, say $10 or $20 dollars cannot do that because of the prohibitive cost of transfer fees, which sometimes exceeds the value of transferred monies. Travelers are invariably worried about losing their money, get robbed, or run out of funds while people without the exact change cannot pay for small purchases such as coffee, sandwiches or magazines from vending machines or pay for car parking.

This invention, the Virtual Money System, will solve all above-mentioned problems and liberate people worldwide from current financial constraints and limitations.

### BRIEF SUMMARY OF THE INVENTION

This invention will empower people worldwide to literally carry in their heads their personal bank accounts wherever they go and wherever they live, whether in small towns in Africa, modern cosmopolitan cities in Europe, or onboard a huge cruise ship off the coast of Alaska. With this magical, personal bank account people will be able to get cash, transfer funds around the world at any time they like and receive codes that can be converted into cash instantly.

To carry out all these financial activities and more, customers will only be required to create and memorize two easy-to-remember codes, write them on a piece of paper, mobile phone or simply commit them to memory. That's all. In short, this invention will enable people worldwide to literally carry their money in their heads and empower them to cash out their Digital Money Codes at any ATM in the world. It will liberate people from all current financial constraints and limitations and give their money wings to fly and land at any point in this world.

The invention envisages a global network of banks selling Digital Money Codes online or via their ATMs or via mobile phone carriers, henceforth Telecoms for short. Telecoms will also be able to offer their customers varieties of Digital Money Codes, independently of banks.

The Digital Money Code is operationally linked to a second code. The Digital Money Code consists of numerical, alphanumerical or alphanumerical with symbols, and the second code, consists of numerical, alphanumerical, or alphanumerical with symbols, and is called the Secret Number. A customer may purchase a Digital Money Code in one location and use it to get cash from an ATM in another location, whether in the same city in which the Digital Money Code was purchased or right across the world. After typing in the Digital Money Code and the corresponding Secret Number the ATM will dispense either the entire monetary value of the Digital Money Code or part of it, per user's instructions.

By saving the Digital Money Code and corresponding Secret Number on a piece of paper, mobile phone or simply commit it to memory, this invention will afford customers financial security, flexibility and mobility and allow people young and old to purchase products, services, movies, music, songs and games from the Internet. Customers should keep a second copy of the ATM printout containing the Digital Money Code and corresponding Secret Number in a secure place, in case they lose the original copy.

### BRIEF DESCRIPTION OF THE SEVERAL VIEWS OF THE DRAWINGS

There are no drawings.

### DETAILED DESCRIPTION OF THE INVENTION

Throughout this document relevant abbreviations will be used. Where these abbreviations are used they stand for as follow:

VMS: Virtual Money System.

DMC: Digital Money Code.

DMCT: Digital Money Code via mobile phone.

DMCF: Digital Money Code coffee.

SN: Secret Number.

AN: Authentication Number. Each code is used only once.

NN: Net Number (Internet number). Each code is used only once.

PRC: Phone Reference Code.

DMC server: Digital Money Code server.

DMC system: An integrated system comprising computerized systems, software programs, data storage systems, Telecom systems, and ATMs.

ATM: Automated Teller Machine.

DMC machine: A machine to sell DMCs via cash and cash out purchased

DMCs already owned by customers.

ATMDMC machine: A machine, which is a combination of an ATM and DMC machine.

This invention, the Virtual Money System, consists of two systems.

The first system is called the Virtual System. It is a virtual system with no hardware, while the second system is called the Digital Money Code system, henceforth DMC system, and it is a physical system with hardware. Each of these two systems is a unique and original system as well as complete and novel system.

The core of the first system, the Virtual System, is the DMC . For the DMC to function and be operational it requires three critical and vital codes: the Secret Number, Authentication Numbers, and Net Numbers, henceforth SN, ANs and NNs, respectively. These three codes are integral and essential parts of the Virtual System. They are totally different from each other and each code has specific functions and unique characteristics.

For instance, the DMC requires the SN to enable customers to draw cash from ATMs.

But if a DMC is purchased via a mobile phone, which then will be called Digital Money Code Via Mobile Phone, henceforth DMCT for short, which will be discussed in more detail later on, then the DMCT will also require the AN, in addition to the SN, to draw cash from an ATM. The DMC needs only one NN per transaction when a customer is purchasing products and services from the Internet. A DMC purchased via a mobile phone will require the AN to be cashed out. Online purchases can be carried out without the use of SNs.

The characteristics of the SN are: when used with a DMC it will enable a customer to draw cash from an ATM, and empower a customer in possession of a DMC to send a DMCT to mobile phones via ATMs as well as to enable a customer having a DMC to buy another DMC via an ATM.

What are the functions and characteristics of the AN? The AN enables customers with DMCTs to get cash from ATMs and it enables customers with DMCTs to purchase products and services from the Internet. One of the most important security features of the AN is that it is used one time only; once used it will become obsolete, permanently useless and inoperable again. Therefore a customer will be compelled to use a new AN for the next online purchase. Therefore, a DMCT does not have a single corresponding AN, but rather multiple corresponding ANs. These multiple ANs are securely created and safely stored on the DMC system server. They are sent to the customer's mobile phone one AN at a time, per customer's need, either when the customer is drawing cash from an ATM or when buying products and services from the Internet.

The AN has different characteristics than the NN. The customer does not have advance knowledge of or access to the ANs, which are created by the DMC server and saved on a specific place on the server. These ANs are sent to the customer's mobile phone when he/she is executing transactions, one AN at a time.

What are the functions and characteristics of NNs and why when we talk about them we use the plural and not the singular? NNs enable customers with DMCs to purchase products and services from the Internet. Without NNs online transactions will not be possible by using DMC's alone. When a customer purchases a DMC from an ATM the DMC system will generate a specific portfolio for that customer and stores it in a specific place on the DMC system server. The portfolio will include the DMC, SN, ANs as well as multiple NNs. In addition to saving them on the server, the ATM printout will also include multiple NNs for the customer. The customer shall need and use the NNs in online transactions. So the NNs have different characteristics than ANs. The customer and the DMC system server have a copy of these NNs. One copy is with the customer, in the form of an ATM printout containing NNs along with the DMC and SN. The second copy is created by the DMC system and is saved on its DMC system server in a specific location created for that specific DMC. One of the most important security features of the NN is that it can be used only once; once used by the customer the DMC system will immediately deactivate it and render it useless. A customer shall need a new NN for the next transaction.

All four codes combined, DMC, SN, ANs, NNs and their corresponding characteristics constitute the Virtual System. When the Phone Reference Code is added to the Virtual System, it will become a highly secure system against all attempts by hackers.

The Virtual System is designed to use, operate and exploit the hardware of the DMC system, which is the second system of the Virtual Money System. The DMC system will enable customers worldwide to use the Virtual System where it enables them to purchase DMCs and cash them out. ATMs, DMC machines, ATMDMC machines, Internet or mobile phones can be used to purchase DMCs while cashing out of DMCs can be carried via ATMs, DMC machine and ATMDMC machines and banks.

Other codes, can be added, integrated and combined with the Virtual System to enhance, expand, upgrade and upscale the Virtual System.

The second system, called the DMC system, is a physical system which comprises computerized systems, software programs and data storage systems, Telecoms systems and Internet and other communication networks and devices as well as other integral networks and ATMs, DMC machines and ATMDMC machines. Other systems, machines and devices can be added, integrated and combined with the DMC system to enhance, expand, upgrade and upscale the DMC system.

When the two systems, the Virtual System and the DMC system are combined the result is the Virtual Money System, henceforth VMS for short. The VMS is a complete system and will enable customers to buy DMCs and cash them out in different ways.

The DMC system saves each DMC and its corresponding data in a specific dedicated position on the DMC system's memory. Each created DMC will have its corresponding SN, ANs, and NNs as well as the original monetary value of the DMC, its remaining current balance plus all deactivated NNs, which can no longer be used again, plus customer's name, address, personal details, mobile and landline telephone numbers and email address. The DMC system will also save all corresponding DMC transactions, such as when the DMC was first purchased as well as dates, times and locations of all subsequent DMC transactions.

A VMS will enable customers worldwide to convert their cash to DMCs and cash out their purchased DMCs at different locations, whether locally or globally, as well as to enable customers to transmit purchased DMCs instantly to recipients anywhere in the world and empower them to convert transmitted DMCs to cash at any time they want.

The DMC system has an important and critical right arm called the DMC Mobile Phone Center. The function of the DMC Mobile Phone Center is to act as a gateway through which Telecoms communicate with the DMC system.

The DMC Mobile Phone Center can be a single center located at the same location of the DMC system, or it can be multiple centers located in different places, either one such center in each country or one such center associated with each Telecom.

This invention envisages a global network of banks selling DMCs online or via their ATMs or via Telecoms. Telecoms will also be able to offer their customers varieties of DMCs independently of banks.

This system consists of two main codes. The first code, numerical, alphanumerical or alphanumerical with symbols, is called as stated before the Digital Money Code (DMC), and the second code, numerical or alphanumerical, and again as stated earlier, is called the Secret Number (SN). A customer may purchase a DMC in one location and use it to get cash from an ATM in another location, whether in the same city in which the DMC was purchased or right across the world. After typing in the DMC and the corresponding SN the ATM will dispense either the entire monetary value of the DMC or a part of it, per user's instructions.

By saving the DMC and corresponding SN on a piece of paper, mobile phone or simply commit it to memory, this invention will afford users financial security, flexibility and mobility and empower people young and old to purchase products, services, movies, music, songs and games from the Internet. Users should keep a second copy of the DMC and corresponding SN in a secure place, in case they lose the original copy.

This invention will enable people to buy DMCs of different monetary values from ATMs and pay for them by cash, cash cards, debit cards or credit cards. The ATM printout will contain two codes, the DMC and SN.

To further increase the security level when purchasing DMCs from ATMs, banks may opt to print only the DMC and send the corresponding SN via the DMC system to customer's email or mobile phone as a short text message.

Family members may share the DMC and corresponding SN among themselves carefully and cautiously either verbally, via phones, email or text messages and use them to get cash from ATMs, whether they live in the same city or dispersed in different parts of the world.

Future ATMs will have a DMC option. Other ATM options, DMCT and DMCF, will be discussed later. By clicking the DMC option on the ATM screen three slots will appear. Upon typing the DMC, corresponding SN, and desired monetary value in the appropriate slots on the ATM screen, the ATM will dispense the requested cash. When the entire value of the purchased DMC is exhausted through subsequent transactions, this particular DMC can then be discarded.

Potentially, a hacker can compromise a DMC and its corresponding SN when these two codes are used in online transaction by a customer. If a hacker succeeds in getting the DMC and SN then he can cash out the DMC. Therefore, each DMC, when sent to a customer, will be accompanied by several corresponding NNs. These NNs will be printed out along with the DMC when a customer buys a DMC from an ATM. Alternatively, the DMC system can send the NNs to the customer's mobile phone or email address, per customer's preference and instructions.

Each NN can be used online only once with a DMC to purchase products and services from the Internet. As soon as on NN is used, the DMC system server will deactivate it immediately, to thwart hackers from using it again. The NNs are very useful, but will only be used for online purchases. They are not needed at all to draw cash from ATMs. Thus, they can be kept safely at home and used only whenever they are needed for online purchases. In a nutshell, to execute transactions at ATMs a customer will only need his/her DMC and SN, while in online transactions he/she will only need his/her DMC and NN. Since the NN can be used only once, therefore if a hacker gets the DMC and NN, they will be useless to him because the legitimate DMC owner has already used that NN in online transaction. The SN is neither needed for online transactions nor can be used by mobile phones.

The use of NN with a DMC can be skipped, if a customer prefers to receive the corresponding AN on his/her mobile phone. In this situation the customer will be using the AN, and not the NN, with his/her DMC. By receiving the AN on his/her mobile phone and using it in online purchases the customer will not be compelled to reveal his/her SN to any vendor or website in online purchases.

Millions of people worldwide have no credit cards or bank accounts and consequently are unable to purchase DMCs. To solve this problem banks can collaborate with Telecoms and sell DMCs through them. The current collaboration between banks and Telecoms worldwide will deepen and expand exponentially, as people start using DMCs in all kind commercial transactions.

Banks can create DMC Mobile Phone Centers and dedicate a special number, say 666, to enable customers to buy DMCs. DMCs sold through DMC Mobile Phone Centers have different characteristics than those sold via ATMs. DMCs sold through DMC Mobile Phone Centers will be called “Digital Money Code via Telephone”, DMCT for short. The process of purchasing a DMCT involves the customer sending a short text message via his/her mobile phone to 666 of the DMC Mobile Phone Center specifying the desired monetary value of the DMCT, for example $100 dollar. The customer will send the message in the following format: ($100 DMCT). As soon as the customer presses the “Send” key on the mobile phone the DMC Mobile Phone Center will instantly send the customer a short text message to his/her mobile phone. The received message will include the DMCT and the corresponding SN. The customer will write down the two codes and subsequently use them to cash out the DMCT at an ATM or use them to purchase products and services on the Internet.

ATMs will also have a DMCT option. When a customer selects this option, he/she is presented with four slots to be filled in; the first is to type in the DCMT, the second the SN, the third is the desired monetary value and the fourth the AN. It is important to keep in mind the following critical fact that at this stage the customer does not yet have his/her AN.

As soon as the customer fills in the first three slots, i.e. the DMCT, SN, and desired monetary value, and clicks OK, a message will appear on the ATM screen telling the customer that a short text message has been sent to his/her mobile phone and that he/she should use the received AN in the appropriate slot. Upon checking his/her mobile phone the customer will notice that he/she has received a new message. The message contains the AN sent by the DMC system. The customer will type in the received AN in the appropriate slot on the ATM screen and as soon as the customer clicks OK, the ATM will dispense the exact monetary value specified by the user.

The AN is a critical security measure and without it is absolutely impossible to cash out a DMCT, even if a hacker has succeeded in getting hold of the DMCT and corresponding SN. A hacker will need all three components, the DMCT, SN and AN, all at the same time, to be able to cash out a DMCT; an impossible deed for anyone to accomplish. The reason for that impossible goal is this: even if a hacker has managed to illegally get hold of the DMCT and corresponding SN, it will be absolutely impossible to get hold of the AN, since the hacker will not only need to be standing next to the legitimate DMCT customer beside the ATM at the exact moment the legitimate customer is trying to cash out the DMCT but the hacker also needs to get hold of the legitimate purchaser's mobile phone device, get his/her permission to open the mobile phone device and read the message sent by the DMC system which contains the vital AN. Thus, we can deeply appreciate the impossible task. Without having the DMCT, SN and the physical mobile phone device of the legitimate DMCT customer, all at the same time, a hacker cannot cash out a DMCT. In a nutshell, a hacker will need all three codes simultaneously, especially the AN which can only be acquired from the purchaser's mobile phone device, to illegally cash out a DMCT, because the DMC server has linked the DMCT and SN to the purchaser's mobile phone number. This high level of security makes DMCTs a very secure form of virtual money which no one can steal or compromise. But later on we shall assume a worst case scenario where a customer has lost his/her mobile phone and a thief was able to read the message within the mobile device containing the DMC and SN. In such situations it is easy for a thief to cash out a DMC, but not if the customer had previously registered his/her mobile phone number with the DMC system and has obtained a Phone Reference Code (PRC). This point will be revisited in more detail later on.

Can the DMC Mobile Phone Center be used to send money abroad? The answer is absolutely yes. Imagine Tom who lives in the USA and he wants to send his mother who is vacationing in London, UK, $1,000. Tom's mother has a local British mobile phone number from BT while she is on vacation. First, Tom will send a message to 666 of ATT. This number is a dedicated number to receive customers' requests to purchase Bank of America DMCTs. To execute these requests Bank of America has established a DMC Mobile Phone Center to receive the purchase requests from ATT. Tom's message will include his mother's British mobile phone number and the monetary value he wants to send her. The purchased DMCT will link together Tom's American mobile phone number with his mother's British mobile phone number.

Next the DMC Mobile Phone Center will send an identical message, which includes the DMCT and the corresponding SN, to both mobile phones. This will enable Tom and his mother, to use the same DMCT, if they wish to draw cash from any ATM in the US, UK, or anywhere else in the world.

When the mother receives the DMCT message on her British mobile phone, she can go to any ATM in London, or any other British city, to cash out the DMCT. As soon as she types in the DCMT, the corresponding SN and the desired monetary value in the appropriate slots on the ATM screen and clicks OK, a message will appear on the ATM screen telling her that a short message containing the AN has been sent to her mobile phone number and that she should type in the received AN in the appropriate slot on the ATM screen. Upon typing in the AN in the appropriate slot on the ATM screen and clicking OK, the British ATM will dispense the requested cash.

To provide customers with another convenient way to purchase DMCTs at anytime and anywhere in the world, the VMS will empower customers to purchase DMCTs via mobile phones and pay for them by credit cards. Whether the monetary value of the purchased DMCT is small or large customers can purchase DMCTs from the comfort of their homes or while in motion. They can do that in the city they live in or while travelling on business or vacation.

Sally Johnson for instance, while cooking dinner at home in Phoenix, Arizona, decided to buy $2,000 worth of DMCT by sending a short text message to 555 of the DMC Mobile Phone Center of Wells Fargo Bank. Later on, while on vacation in Paris, France, she bought [symbol] 3,500 worth of DMCT while watching TV in her room in the Hilton Hotel in Paris by sending a short text message to 353 of the DMC Mobile Phone Center of Bank of Paris.

In both transactions, Sally used her American mobile phone to buy the two DMCTs. To pay for the DMCTs she used her Visa credit card. Her message to 555 of the Mobile Phone Center of Wells Fargo Bank in Phoenix, Ariz., included 5 lines. In the first line Sally typed her US mobile phone number, in the second “Buy DMCT”, in the third, $2,000, in the fourth her email address and the fifth her Visa credit card no.

619 444 3213

Buy DMCT

$2,000

SallyJohnson@aol.com

4115 7452 2937 08110

Her message to Bank of Paris is almost similar, except for the currency and monetary value of the DMCT.

00 619 444 3213

Buy DMCT

[symbol] 3,500

SallyJohnson@aol.com 4115 7452 2937 08110

When purchasing her DMCT in the US, as soon as she presses the “Send” key on her mobile phone the DMC system will immediately send Sally a short text message telling her that an attempt has been made from this mobile phone number to charge her credit card $2,000 worth of DMCT and in order to confirm the purchase she (Sally) needs to send the CCV and PIN of the Visa credit card to 555 of the DMC Mobile Phone Center of Wells Fargo Banks. As soon as Sally sends back the CCV and PIN of her Visa credit card, the DMC system will immediately send her a short text message containing her DMCT and SN. Needless to say the DMC system will also send the DMCT and SN codes to her email address. The process to purchase a DMCT in Paris is exactly the same as in Phoenix. Both involve sending a short text message to a well-advertised center designed and maintained to receiving DMCT purchase requests by customers.

Here we should recognize an important fact. While Wells Fargo Bank in Phoenix may be where Sally maintains her checking and savings accounts, Bank of Paris is not. The VMS will empower customers to buy DMCTs from any bank in the world and pay for them by credit cards. Buying DMCTs by credit cards afford customers convenience, mobility and flexibility. Sally for instance can convert her American and French DMCTs to cash in France as well as transfer money back to her friends in the US, or anywhere in the world, using her two DMCTs, as explained earlier with John and Herman.

Using mobile phones to buy DMCTs via credit cards 24/7 anywhere in the world will save customers trips to ATMs. In a nutshell: if a customer has a credit card and mobile phone then he/she can buy a DMCT and have it sent to his/her mobile phone. Of course, after receiving the DMCT on his/her mobile phone, a customer using an ATM can change the two received codes, the DMCT and SN, to two easy-to-remember DMCT and SN, as explained previously.

In the last two decades the telecommunication sectors has witnessed unprecedented technological breakthroughs and satellite services have progressed at an incredible speed. Advance modern Telecoms give subscribers convenient mobility and global service. An ever expanding network of Telecoms forward messages among billions of subscribers scattered all over the world.

In the last fifteen years we've grown accustomed to receiving our text messages on our mobile devices as we cross international borders; nowadays messages follow us like our shadows wherever we go. When a subscriber travels from one country to another, the roaming feature on the mobile phone will use the service provided by a local Telecom and the phone's built-in GPS will facilitate the delivery of messages sent from different parts of the world.

So, when Tom buys his mother a DMCT from Bank of America, the DMC system will send an identical DMCT message, containing the DMCT and corresponding SN, to Tom and his mother. ATT will deliver Tom's copy to his mobile phone device instantly. To deliver his mother's copy, ATT will send her copy to the British carrier BT which will instantly deliver the message to her British mobile phone number.

To make certain that only the intended recipient should receive the money; the DMC Mobile Phone Center can check and confirm that the mobile phone number of the intended recipient and the to-be-used-ATM are in the same location. When a match is determined the money will be dispensed. Therefore all future ATMs should have location-identification capability similar to mobile phones. This extra security measure can easily be added to all ATMs worldwide. By creating a global directory of all ATMs and their locations a software program of the DMC Mobile Phone Center will be able to compare and match the location of an ATM with the mobile phone number of the intended recipient of the DMCT from the global directory which will need constant updates when new ATMs are added.

One version of DMCs comes without the need for a corresponding SN. It is usually used to buy coffee, sandwiches or other small purchases, of less than $10 dollars for instance, and it is called “DMC coffee”, henceforth DMCF for short. If the DMCF is compromised, the loss is very small, thus there is no need for a corresponding SN.

How can a customer buy a DMCF?

The customer sends a short text message to 666 of the DMC Mobile Phone Center, in the following format: ($5 DMCF), expressing the need to buy five-dollar worth of DMCF. The customer will immediately receive a message, which includes the DMCF or a DMCF plus a bar code. The customer can now either type in the DMCF to get the coffee or alternatively, the camera incorporated into the coffee machine can take a picture of the DMCF or the bar code and send it to the DMC Mobile Phone Center to check the authenticity of the data in order to authorize dispensing the coffee to the customer.

To simplify the process of purchasing coffee for instance, the DMCF should simply be the purchaser's mobile phone number plus 4 or 5 digits. For example if his/her mobile number is 703-555-1212 then the DMCF message sent to the customer should read either 703-555-1212-4433 or 703-555-1212-44332. In this manner the customer need only memorize the last 4 or 5 digits of the DMCF message. As soon as the customer types in his/her mobile number, followed by the extra 4 or 5 digits, coffee will be dispensed.

This invention will empower people worldwide to purchase with cash DMCs in one location and cash them out in another location, whether in the same city in which the DMC was purchased or right across the world, as well as to send DMCs to people anywhere in the world and enable them to cash them out. This invention will also give people different ways of buying and spending DMCs, they can buy them via ATMs, Internet, mobile phones, DMC machines and/or ATMDMC machines, and cash them out via ATMs, DMC machines and/or ATMDMC machines.

Below is a summary of different ways customers can use to buy and cash out DMCs.

First at ATMs:

A customer will be able to purchase a DMC from an ATM via cash, cash card, debit card or credit card and receive an ATM printout of the DMC.

A customer will be able to purchase a DMC from an ATM via cash, cash card, debit card or credit card and save it on a magnetic card.

A customer will be able to purchase a DMC from an ATM via cash, cash card, debit card or credit card as well as create his/her own easy-to generate-easy-to-remember DMC and corresponding SN to liberate users from the need to carry an ATM printout of the DMC or a copy of it on a piece of paper and free them from the fear of losing these vital codes.

A customer will be able to purchase a DMCT from an ATM via cash, cash card, debit card or credit card and receive the DMCT on his/her mobile phone or any other mobile phone specified by him/her.

A customer will be able to purchase a DMCF from an ATM via cash, cash card, debit card or credit card and receive an ATM printout of the DMCF.

A customer will be able to cash out his/her DMC at an ATM.

A customer will be able to cash out his/her DMCT at an ATM.

A customer will be able to cash out his/her DMCF at an ATM.

Second at DMC machines:

A customer will be able to purchase a DMC from DMC machines via cash and get a printout of the DMC.

A customer will be able to purchase a DMCT from DMC machines via cash and receive the DMCT on his/her mobile phone or any other mobile phone specified by him/her.

A customer will be able to purchase a DMCF from DMC machines via cash and receive a printout of his/her DMCF.

A customer will be able to purchase a DMC from DMC machines via cash, and save it on a magnetic card.

A customer will be able to purchase a DMC from DMC machines via cash, and as well as create his/her own easy-to-generate-easy-to-remember DMC and corresponding SN to liberate users from the need to carry their DMC printouts or copy of them and to free them from the fear of losing these vital codes.

A customer can cash out his/her DMC at DMC machines.

A customer can cash out his/her DMCT at DMC machines.

A customer can cash out his/her DMCF at DMC machines.

Third at ATMDMC machines:

A customer will be able to purchase a DMC from ATMDMC machines via cash, cash card, debit card or credit card and get a DMC printout.

A customer will be able to purchase a DMCT from ATMDMC machines via cash, cash card, debit card or credit card and receive the DMCT on his/her mobile phone or any other mobile phone specified by him/her.

A customer will be able to purchase a DMC from ATMDMC machines via cash, cash card, debit card or credit card and save it on a magnetic card.

A customer will be able to purchase a DMC from ATMDMC machines via cash, cash card, debit card or credit card and as well as create his/her own easy-to-generate-easy-to-remember DMC and corresponding SN to liberate users from the need to carry their DMC printouts or copy of them and to free them from the fear of losing these vital codes.

A customer will be able to purchase a DMCF from ATMDMC machines via cash, cash card, debit card or credit card and receive a DMCF printout.

A customer will be able to cash out his/her DMC at ATMDMC machines.

A customer will be able to cash out his/her DMCT at ATMDMC machines.

A customer will be able to cash out his/her DMCF at ATMDMC machines.

Fourth at Telecoms:

A customer will be able to purchase a DMCT via his/her mobile phone or any other telecommunication device, and receive the DMCT as a message sent either to his/her mobile phone or email address or both, per his/her preference and instructions.

A customer will be able to purchase a DMCT for someone else via his/her mobile phone or any other telecommunication device, and that individual will receive the DMCT as a message sent either to his/her mobile phone or email address or both, per the purchaser's preference and instructions.

DMCTs and DMCFs purchased via mobile phones, or any other telecommunication devices, can be cashed out at any ATM, DMC machine, ATMDMC machine, or bank.

Fifth at Internet:

A customer will be able to purchase a DMC from vendors online via cash card, debit card or credit card. Upon receiving the DMC details, the customer can print out his/her

DMC as well as save the details on the computer's hard disk or on a separate piece of paper.

A customer will be able to purchase a DMCT from vendors online, via cash card, debit card or credit card and receive the DMCT details on his/her mobile phone or any other mobile phone specified by him/her.

A customer will be able to purchase a DMCF from vendors online, via cash card, debit card or credit card. Upon receiving the DMCF details, the customer can print out his/her DMCF as well as save the details on the computer's hard disk or on a separate piece of paper.

All DMCs, DMCTs and DMCFs purchased from vendors online can be cashed out at any ATM, DMC machine, ATM DMC machine or bank.

Sixth buying DMC or DMCT via DMC or DMCT:

Any DMC or DMCT can be used to purchase another DMC or DMCT via any of these methods or devices: ATM, DMC machine, ATMDMC machine, Internet, mobile phones, or any other telecommunication device.

To roll out this system banks must first establish Digital Money Code servers, henceforth DMC servers for short, empowered by powerful software programs capable of generating highly secured DMCs. Each newly created DMC will have its corresponding SN, ANs, and NNs where all linked to the monetary value of the DMC.

Banks will be required to install DMC servers and establish DMC Mobile Phone Centers to execute all these transactions in close collaboration and coordination with servers of Telecoms, such as ATT, Verizon or British Telecom, to enable people buy DMCTs. All data on bank servers will be encrypted to thwart hacking.

Banks will enable ATMs to sell DMCs. When a customer clicks on the DMC tab, he/she will be asked to select the desired DMC monetary value. The customer will have the choice to inserts his banknotes, cash card, debit card or credit card to pay for the DMC. Finally, the ATM will issue a printout of the DMC and the corresponding SN and NNs. Alternatively, the ATM may only print the DMC while the DMC system will send the SN and NNs as a short text message to the purchaser's mobile phone or email address.

Telecoms may also sell DMCTs directly to customers, after establishing shared business agreements with banks, to allow customers to convert their purchased DMCTs at ATMs. Telecoms, will not only reap enormous profits but the huge sales volume will give them, at any particular moment, access to billions of dollars, as customers are not liable to cash out their DMCTs immediately or spend them instantly in one transaction on the Internet.

ATMs will have an option to save DMCs on magnetic cards. Blank magnetic cards will be made widely available in all sorts of kiosks, utility shops, and department stores. To save a DMC on a magnetic card using an ATM the customer first needs to buy a blank magnetic card. Next the customer will type in the DMC, inserts the blank magnetic card into the ATM and choose the option “Save DMC on Magnetic Card”. As soon as the customer clicks OK the ATM will save the DMC on the magnetic card and the process is completed.

This will not only provide customers with a handy and portable way to carry around a substantial amount of cash securely and conveniently in their pockets but saving the DMC on a magnetic card will also eliminate the need to type the DMC in future transactions; from now on the customer will need only to type in the corresponding SN, in addition to the desired monetary value of course. Saving a DMC on a magnetic card has reduced the necessary codes from two to one. i.e. before saving the DMC on a magnetic card the customer needed to type in the DMC and SN to cash out a DMC, but after saving the DMC on a magnetic card the customer will be asked only for the corresponding SN to cash out a DMC.

The DMC in reality is another form of money. The customer can use it to purchase products and services from the Internet as well as all sorts of products, items and articles in shops and department stores and to pay for meals in restaurants by using the DMC magnetic card. A DMC will conveniently allow customers to securely and easily make all kind of purchases.

The option to change a DMCT to a DMC is one of the options on the ATM. Let us remember that while a DMCT requires AN, a DMC does not. To execute the conversion process from DMCT to DMC, first the customer will choose “Change DMCT to DMC” option on the ATM. The customer will be asked to type in the DMCT and corresponding SN. As soon as he/she clicks OK, a message will appear on the ATM screen stating that a short text message containing the AN has been sent to the user's mobile phone. Upon typing in the received AN in the appropriate slot on the ATM screen and pressing OK the DMC system will generate a new DMC and new SN, where the DMC will be printed by the ATM while the SN will be sent as a short text message to the user's mobile phone, so the conversion process from DMCT to DMC is completed. By converting the DMCT to DMC, the new DMC will require only the SN and will no longer require the AN in future transactions.

The customer can change the DMCT to a DMC and at the same time save the DMC on a blank magnetic card. To achieve that, the customer will carry out the conversion process outlined in the previous paragraph, then inserts a blank magnetic card into the ATM, select “Save DMC on Magnetic Card” and clicks OK. The DMC system will save the new DMC on the magnetic card and the process is completed. By saving the DMC on a magnetic card, we've eliminated the need for the AN to be used with the new DMC. In addition to saving the DMC on the magnetic card, the ATM will also generate a printout of the new DMC as a safety measure in case the customer losses his/her magnetic card. With the newly created magnetized DMC the customer will only need the new SN, which the DMC system has sent as a short text message to the customer's mobile phone. What the customer has in essence now is a magnetized DMC card, not different at all from any MasterCard or Visa credit card. The magnetized DMC can easily and conveniently be used for all kind of purchases, needing only the corresponding SN.

Can a DMC be changed? For instance, from a hard-to-remember DMC linked with a hard-to-remember SN to an easy-to-remember DMC linked with an easy-to-remember SN? The answer is again, absolutely yes. Future ATMs will have “Change DMC” option. When a customer selects the “Change DMC” option, the ATM screen will reveal six slots or more. At this stage the customer can decide whether he/she wants the ATM to issue the new DMC and corresponding SN on the same printout or send the SN as a short text message to his/her mobile phone. The first choice involves the customer typing in only four slots: the original DMC in the first slot, the original SN in the second slot, the new easy-to-remember DMC in the third slot, created by the customer and not computer-generated, and in the fourth slot the new easy-to-remember SN created by the customer, consecutively. As soon as all four codes are typed in, and the customer clicks OK, the ATM will issue the customer a printout containing two new easy-to-remember codes, the DMC and SN. The “Change DMC” tab has enabled the customer to generate easy-to-remembered DMC and SN, two codes forever engrained in his/her brain. The new codes are the customer's preferred memorable codes and not some hard-to-remember codes randomly generated by a computer.

The second choice involves the customer filling in six slots on the ATM screen: the original DMC in the first slot, the original corresponding SN in the second slot, a new easy-to-remember DMC in the third slot, and a new easy-to-remember corresponding SN in the fourth slot and his/her mobile phone number in the fifth slot and his/her email address in the sixth slot, consecutively. As soon as all six slots are filled in and the customer clicks OK, the DMC system will send him/her the new easy-to-remember DMC to his email and send the SN as short text message to his/her mobile phone plus the ATM will generate a printout containing the DMC and SN.

The “Change DMC” option will liberate people from carrying their DMCs and corresponding SNs on paper or mobile phones and put an end to their fear of losing them. Furthermore, because of the flexible power of ATMs to allow users to easily and conveniently create easy-to-remember DMCs and SNs, users will be able to use the ATM easily, accurately and quickly. Typing the DMC and SN on the ATM will become a second nature to them. From now on people will literally carry in their heads all their money and all they have to do is to remember two easy-to-remember codes, the DMC and SN, both created by them.

Another option on the ATM will allow people to create and purchase their own preferred DMC directly. The simple, straightforward process involves the customer choosing the “Purchase DMC” option. In this case the screen will show three slots only. In the first slot the customer will type in his/her preferred easy-to-remember DMC, which can be numerical, alphanumerical or alphanumerical with symbols and in the second slot the customer will type in his/her preferred easy-to-remember corresponding SN, which again can be numerical, alphanumerical or alphanumerical with symbols, in the third slot he/she types the amount of money he/she wants to convert into DMC. As soon as the customer clicks OK, a message on the

ATM screen will ask the customer for payment. The customer can pay by banknotes, cash cards, debit cards, or credit cards. As soon as the customer clicks OK the ATM will issue the customer a printout containing the DMC and corresponding SN. The customer has also the choice of receiving the DMC and corresponding SN on his/her email and mobile phone as well as to get both, as an ATM printout and as a short text message sent to his/her mobile phone. The beauty of allowing customers to choose and generate their preferred DMCs and SNs means that customers will not forget their codes anymore and no longer need to carry ATM printouts, papers, notes or save these codes on their mobile phones. Their codes will be forever engrained in their heads and as simple as remembering their names and birthdays.

Current ATMs are accessible only by users carrying ATM cards, cash cards, debit cards or credit cards. But what about people, who have no bank accounts, ATM cards, debit cards, cash cards or credit cards? How can they buy DMCs, if they want to do so?

To solve the above problem, a new machine capable of selling DMCs to people who have no bank accounts, ATM cards, debit cards, cash cards and credit cards will be introduced to the market. The new machine will be called DMC machine. Customers will be able to insert their banknotes into the DMC machine to purchase DMCs as well as cash out purchased DMCs. A standard ATM can also be modified and converted into DMC machine to save banks investment costs.

By giving people worldwide the opportunity to easily create their own DMCs, billions of people will be empowered to access, use, and maintain a DMC account, which is not dissimilar at all to conventional checking accounts. Customers will be able to add money to their DMCs as well as cash out part or all of it. They will be able to carry out these financial transactions locally as well as globally. By maintaining a small balance in their DMC accounts customers will be able to have and maintain what we might call a “Permanent DMC.

Adding cash to an existing DMC will not be limited to DMC machines. Customers will also be able to add cash to their DMCs via ATMs. Furthermore, customers with conventional bank accounts, such as checking and saving, who have already existing DMC accounts, can transfer money from any regular bank accounts to their DMC account via ATMs, using, cash card, debit card or credit card.

To add cash to an existing DMC using a DMC machine, a customer will select “Add funds” option, punch in his/her DMC and corresponding SN and click OK. A message on the screen of the DMC machine will ask the customer how much he/she wants to add to the DMC. After specifying the monetary value the customer can feed the banknotes into the DMC machine.

By integrating the most advanced features of current ATMs with innovative features of the DMC machine, a new, highly versatile, cutting-edge machine will emerge which we can call ATMDMC machine. The new ATMDMC machine will allow customers to buy DMCs with banknotes, cash cards, debit cards, or credit card.

Made universally available worldwide, these ATMDMC machines will empower billions of people who never had bank accounts before, to establish and maintain bank accounts for the first time in their lives. ATMDMC machines will allow customers to open “Permanent DMC” accounts, a kind of regular checking account, which will allow customers to add monetary value to it or draw cash from it. The ATMDMC machine is not only practical but also very flexible. It will enable customers to easily create their own personal easy-to-remember numerical, alphanumerical or alphanumerical with symbols codes. Thus, ATMDMC machines will empower people worldwide to effortlessly create and literally carry in their heads their checking accounts. However, unlike a conventional checking account, a “Permanent DMC” is virtual, global, memorable, portable, flexible, and mobile.

All future ATM, DMC and ATMDMC machines should have a full alphanumerical QWERTY keyboard, with an upper and lower case capability. This will allow customers to create an easy-to-remember DMC and “Permanent DMC” accounts.

Customers can be quite imaginative and inventive in creating easy-to-remember DMCs. For example, by combining the name of an individual, David, with the name of a city, London, and year of birth, 1959, a customer can create an easy-to-remember DMC: (DAVID London 1959)

The same DMC mentioned above can also be created in many other versions; examples:

| | | | | |
|---|---|---|---|---|
| DAVID | London | 1959 = | DMC: | DAVIDLondon1959 |
| DAVID | LONDON | 1959 = | DMC: | DAVIDLONDON1959 |
| David | London | 1959 = | DMC: | DavidLondon1959 |
| david | London | 1959 = | DMC: | davidLondon1959 |
| David | London | 1959 = | DMC: | DavidLondon1959 |
| DAVIDLON- | | | | |
| DON1959 | | | | |

The above DMC example can also be changed to many different formats:

| | | |
|---|---|---|
| DAVID LONDON 1959 | = DMC: | DAVIDLONDON1959 |
| LONDON DAVID 1959 | = DMC: | LONDONDAVID1959 |
| 1959 LONDON DAVID | = DMC | 1959LONDONDAVID |
| 1959 DAVID LONDON | = DMC | 1959DAVIDLONDON |
| DAVID 1959 LONDON | = DMC | DAVID1959LONDON |
| LONDON 1959 DAVID | = DMC | LONDON1959DAVID |

The standard QWERTY keyboard has 26 lowercase letters and 26 uppercase letters and 10 numbers. Thus, we have a total of 62 possible characters to choose from. So, if a DMC is created using 15 characters, as in the example quoted above, the possibilities of different DMCs will be 15 raised to power 62 i.e. the number of possible DMCs a customer can create is: 8.272 followed by 72 zeros or 8.272 trillion trillion trillion trillion trillion trillion DMCs. Therefore, the co-existence of two similar DMCs at the same time will never ever happen. Let us also remember that the DMC is actually created by the customer and is quite memorable.

Now we may ask an important question about the DMC and DMCT. How flexible, practical, useful or valuable are they?

To demonstrate their exceptional value, global impact, and the myriad of services they offer customers worldwide let us consider two scenarios.

In the first scenario we shall encounter a situation where a DMC is used to purchase a DMCT. In our imagined story, before flying to Japan for vacation, John, who lives in Baltimore, Md., USA, buys a $5000 DMC from an ATM in Baltimore. The ATM will issue John a printout that contains the DMC and corresponding SN. John decided to save his purchased DMC on a blank magnetic card for convenience. While he is in Tokyo, Japan, John's German friend Herman, who lives in the capital Berlin, calls John and asks for $1,000. John proceeds immediately to the nearest ATM in Tokyo, inserts his DMC magnetic card, types in the corresponding SN, clicks on the “Purchase DMCT” tab, chooses $1,000 and enters Herman's German mobile phone number and clicks OK. Herman will instantly receive a message on his German mobile phone, which includes a DMCT and corresponding SN. Herman can now go to any ATM in Berlin, or any city in Germany for that matter, to draw cash. For the time being, Herman needs only $300. He simply types his DMCT, SN and chooses $300 and clicks OK. A message will appear on the ATM screen stating that AN has been sent to his, Herman's, mobile phone and that he should type in the received AN in the appropriate slot on the ATM screen. After reading the message on his mobile phone Herman will type in his AN in the appropriate slot on the ATM screen and clicks OK. The ATM now will dispense $300. Next, Herman's son George who lives in Sydney, Australia, calls to ask his dad for a quick $500. Herman will rush to the nearest ATM in Berlin, and just like his American friend John, he clicks on “Purchase DMCT” tab, types in his DMCT and corresponding SN, two codes which he received as a result of John's transaction, selects $500, and types in his son's Australian mobile phone number. As soon as Herman clicks OK a message will appear on the ATM screen telling Herman that a message containing the AN has been sent to his mobile phone and that he should type it in the appropriate slot on the ATM screen. Upon typing his AN in the appropriate slot, a DMCT will instantly be sent to George's mobile phone in Australia. George can now go to any ATM in Sydney and draw his $500. Of course, George in turn can also send his $500 or part of it to anyone anywhere in the world.

In each of the transactions mentioned in the above scenario banks will charge a fee of, let us say 0.25-05%. The percentage of fees will be agreed upon by participating banks, benefiting from existing profit sharing agreements and global transmission protocols. Needless to say banks and Telecoms will reap enormous profits as a result of this potentially lucrative business.

Let us now consider the second scenario where a DMCT is used to buy another DMCT. Imagine Robert, a resident of Rockville, Md., who has purchased $1000 DMCT and that he wants to send his wife Helen, who lives in Falls Church, Virginia, $500 DMCT. To do that, using his mobile phone Robert will send a short text message to 666 of the DMC Mobile Phone Center. The message will have five lines. In the first line Robert will type in his DMCT, in the second the corresponding SN, in the third “Buy DMCT”, in the fourth the amount of money Robert wants to send his wife Helen, $500, and in the fifth Helen's mobile phone number.

Robert's short text message to 666 of the DMC Mobile Phone Center will be in the following format:

DAVIDLondon1959

410 627 5152

Buy DMCT

$500

703 671 4483

As soon as Robert presses the “Send” key on his mobile phone the DMC Mobile Phone Center will send an identical DMCT message to Robert and his wife Helen. Next, Helene will proceed to the nearest ATM in Falls Church, type in the received DMCT, corresponding SN and the monetary value desired, whether $500 dollars or less, and as soon as she clicks OK, a message will appear on the ATM screen stating that a short text message containing the AN has been sent to the customer's mobile phone and that the customer should type in the received AN in the appropriate slot on the ATM screen. As soon as Helen types in the AN in the appropriate slot and clicks OK the ATM will dispense the cash.

How does the customer pay for the DMCT? A customer will pay for a DMCT from his/her Telecom airtime account.

When a customer buys a DMCT the Telecoms deduct the value of the DMCT from his/her airtime and send this value to the DMC system.

Therefore, before a customer can buy a DMCT of substantial value he/she should have sufficient airtime in the account to allow his/her Telecom to deduct the necessary airtime and send this DMCT value to the DMC system.

Conversely, DMCTs and DMCs can be used to buy airtime from Telecoms, say ATT. In such an instance, a customer can send a short text message to 122, a number dedicated by ATT to receive customers' requests. The message format is simple and straightforward, as shown below. The first line is the DMC or DMCT, the second is the corresponding NN or SN and the third is the value of airtime the customer wants to purchase, which ATT will deduct from his/her DMC or DMCT.

DAVIDLondon1959

2736345836

$10

Holders of DMCs, DMCTs and DMCFs can walk into banks and convert them into cash. For example a holder of a DMC can walk into any bank in the world and reveal to an officer of the bank his/her DMC and corresponding SN. Upon verifying the two codes the bank can then cash out the DMC. All data on DMC servers and DMC Mobile Phone Center servers will be encrypted to thwart hacking.

A new software program should be created for use by mobile phones. This software program is capable of encrypting the short message a customer sends to the DMC Mobile Phone Center as well as decrypting the encrypted message the customer receives from the same center. Upon decrypting the message sent by the DMC Mobile Phone Center the customer will be able to see the DMC and corresponding SN on his/her mobile phone.

Banks all over the world will also be able to sell DMCs as DMC cards. The DMCs and SNs of bank-issued DMC cards will be invisible and protected beneath an opaque protective coating. When the opaque protective coating is scratched off, both codes will be revealed.

A customer may purchase a DMC card in one location and use it to get cash from an ATM in another location, whether in the same city in which the DMC was purchased or in another city located on the other side of the world. After typing in the DMC and the corresponding SN the ATM can dispense the entire value of the DMC or part of it, per customer's instructions.

In case the intended recipient, for whom the DMCT was purchased, losses or inadvertently erases his/her sms and email message, the DMC system or the Telecom will send the exact DMCT message three times; the exact same message will be sent an hour later after the first time , and the following day for a third time.

To add security to commercial activities, build trust among traders and merchants and prevent fraud, customers buying and sending DMCTs to intended recipients can add the tag or hash sign (#) at the end of mobile phone numbers of recipients. Any other symbol may also be used and added at the end of a mobile phone number such dollar sign, Euro sign or literally any other sign or symbol. The addition of the tag symbol will play a vital role in increasing security and preventing fraud. By tagging recipient's mobile phone number the DMC system will generate two un-identical DMCT messages and sends them to the mobile phone numbers of the buyer and intended DMCT recipient. The DMCT message received by the intended recipient for whom the DMCT was purchased will be a tagged DMCT. The accompanying message will inform the intended recipient the monetary value of the DMCT, that he/she alone will be able to cash out the tagged DMCT, and that he/she alone will get the AN while cashing the DMCT. On the other hand, the customer who bought the DMCT will get a standard, untagged DMCT. The accompanying message will also inform him/her of the monetary value of the DMCT, that he/she will not be able to cash out the DMCT and that he/she will not get the AN if he/she attempted to cash out the DMCT, which he bought for the intended recipient.

Imagine Mr. Brown who wants to sell three beautiful Persian carpets to Mr. Cortez. It is the first time they are trading together and trust between them has not yet been established. The two gentlemen agreed on a price of $3,000. Next, Mr. Brown will ask Mr. Cortez to send him a tagged DMCT worth $3,000. In sending the request for the $3,000 worth of tagged DMCT, Mr. Cortez will tag the mobile phone number of Mr. Brown. The DMC system will generate two un-identical DMCT messages and sends them to the buyer and seller. The message received by Mr. Brown, the seller, will not only show that his mobile phone number has been tagged but will also state that he alone will be able to get the AN and cash out the DMCT. The DMCT message received by the buyer, Mr. Cortez, will be a standard, untagged DMCT and the accompanying message will clearly state that the recipient will not be able to cash out the DMCT and will not get the necessary AN to cash out the DMCT. If Mr. Cortez attempted to cash out the DMCT immediately after getting hold of the three Persian carpets he will fail.

The reason for incorporating this extra level of security is to prevent the buyer, Mr. Cortez in this case, from cashing the DMCT and keeping the three beautiful carpets at the same time. Tagging recipients' mobile phone numbers is another extra security measure to thwart fraud and prevent mischief.

Mobile owners have the option to register their mobile phone numbers with the DMC system by sending a message to 666 of the DMC Mobile Phone Center expressing a desire to have a Phone Reference Code, henceforth PRC for short, linked to their mobile phone numbers.

The reason behind establishing a PRC is to take into consideration situations when customers lose their mobile devices. When this happens thieves can read the received DMCT message along with the corresponding SN. Once a thief reads the DMCT message and knows the DMCT and SN he can cash out the DMCT easily. Once he types in the two codes the DMC system will send him the AN and the ATM machine will dispense the cash. To prevent this unforeseen and unfortunate situation, the adoption and implementation of the PRC will stop criminals compromising this vulnerability. A PRC can be as short as four digits or as long as 20 digits, per owner's preference.

In cashing a DMCT, by typing the DMCT and SN, the ATM screen will ask the customer to type in the AN, which has been sent to his/her mobile phone device. Once the AN is typed in the appropriate slot on the ATM screen, another slot will also be shown to the customer to type in the registered PRC. Once he types the PRC in the appropriate slot and clicks OK, the ATM will dispense the money. If on the other hand the customer's mobile phone number has not been previously registered with the DMC system, the ATM machine will not show the PRC slot and cash will be dispensed without the need for a PRC. Thus, one can immediately realize that if a customer has registered his/her mobile number with the DMC system, thieves cannot cash a DMCT even if they get hold of the DMCT, SN and the customer's mobile phone device.

To cash out a DMCT at an ATM, a customer shall need the DMCT, AN and the SN. But to cash out a DMC, a customer will only need the DMC and the SN; the AN will not be needed.

Concern over security may compel some security experts to demand that a DMC may not be cashed unless combined with the AN; this extra layer of security can easily be implemented. But it can also be optional, as not everyone in underdeveloped countries has a mobile phone.

For further security, each DMC can have two or more SNs. Thus, when using a DMC at an ATM a customer will be asked type in both SNs, if the DMC was issued with two SNs, or four SNs if the DMC was issued with four SNs to complete the transaction.

When buying a DMC from an ATM or from a DMC system on the Internet, such as Bank of America, a customer will be able to specify the maximum monetary value of the DMC that can be cashed within a specific period of time. For example a customer holding a DMC of $800 issued, with two SNs, can give the DMC and one of the SNs to his son to cash out a maximum of $100 per week. An option on the ATM will allow the customer to lock the maximum monetary spending limit within a specific period of time, seven, ten or twenty days. The father on the other hand, can cash out the entire DMC value or any part of it, at anytime he wants, since he has both SNs, which are essential to cashing out the entire DMC.

A customer holding a DMC can draw cash from an ATM by using the DMC and one of the NNs. As soon as one NN is used, it will be deactivated by the DMC system and becomes useless and can no longer be used again. Thus, the holder of a DMC can, as an option, use one of his/her NNs to draw cash from the ATM, and not the SN. This is another option available to customers, to be able to use their NNs with the DMC at ATMs.

When we say DMC Mobile Phone Center what are we referring to? Is it just one universal DMC Mobile Phone Center present in one location next to the DMC server? Yes it can be one single DMC Mobile Phone Center. Or it can be many branches, dispersed in every corner in the world, accessible by customers worldwide and associated with every bank and Telecom in the world.

These centers will work closely and seamlessly with local Telecoms. The DMC Mobile Phone Center of Bank of America in Boston, Massachusetts, for instance, may work with ATT, while the same bank, Bank of America, may decide to have its DMC Mobile Phone Center in California with Verizon. Citi Bank on the other hand may opt to work with Sprint throughout the US, while PNC, which is a big bank in the Eastern US may have several DMC Mobile Phone Centers working with different Telecoms, such as ATT, Verizon, Sprint and T-Mobile in different states. The DMC Mobile Phone Center of Bank of Tokyo may work with Orange. Thus, although DMC Mobile Phone Centers will have universal presence, but in fact they are created by banks, in close collaboration with Telecoms operating in a specific geographical region. Banks may have conventional financial services in one region, but will still be able to offer customers DMCs in regions or countries where they have no physical presence or conventional financial presence. For instance, Citi, Chase and Bank of America, may work closely with two Telecoms in the Gulf, Qtel in Qatar or Etisalat in the UAE, to offer customers in these two Arab countries, DMCs in US dollars, despite the fact that Bank of America does not have conventional banking services in Qatar and the UAE. In a nutshell, DMC system Mobile Phone Centers will be available to customers worldwide; banks working closely with local Telecoms will provide these services to their customers

Children as well adults will love the DMC or virtual money if you like. By using their mobile phones children can buy DMCs of small value called DMCF and use them to buy games, music, movies, songs and toys on the Internet. Adults too can purchase DMCFs and use them to play poker on the Internet. When a customer wins, the gambling company hosting the poker game can simply send his/her winnings as a DMCT. A TV station in France, for example, can instantly reward a viewer in Canada and texts him/her the money he has won as a DMCT in message.

Can multinational corporations benefit from this virtual money? The answer is yes. Trans-national corporations, oil corporations and franchises can use DMCTs to pay salaries of their employees living and working in Africa, Asia, and South America or anywhere in the world. Corporations will be able to integrate DMCT-capable automated payroll software program into their payment system. Each month the system will send workers dispersed all over the world their salaries.

By adopting, integrating and operating DMCT-capable automated payroll software program workers will be able to receive their salaries instantly. Multi-national corporations can save money by reducing the size of their accounting departments and cut down on valuable accounting hours. After tabulating, integrating and linking the names of employees with their overseas mobile phone numbers, the system will be able to automatically send the monthly or weekly salaries of workers to their overseas mobile phones. It is a form of direct deposit, except that workers instead of getting their salaries through their bank accounts they will receive their salaries on their mobile phones. After establishing a complete list of employee names, their salaries, employee mobile phone numbers overseas, and their geographical distribution, the software starts creating sequential messages to buy DMCTs, one message at a time from previously compiled list and send them sequentially, one by one, to 666 of the DMC Mobile Phone Center, where the DMC Mobile Phone Center upon receiving the messages will in turn starts creating DMCT messages and sending them sequentially, one by one to the corresponding mobile phone numbers of the employees, per the list of the multinational corporation.

Upon receiving their DMCTs workers can cash them out instantly, either fully or partially, at ATMs or local banks. In short this system is easily capable of establishing bank accounts for employees working overseas.

If workers have Permanent DMCs the multinational corporation software program, will send their salaries to their Permanent DMCs instead of their mobile phones. At the end of each month workers can go to any ATM and get their salaries via their Permanent DMCs.

When the VMS is operational worldwide, workers overseas, like Max, will be able to send funds to their families day or night via ATMs or by using their mobile phones from the comfort of their homes. Max for example is a Filipino graphic designer. He works in Cairo, Egypt, and he supports his mother and siblings. They live in Manila, Philippines, and each month he has to send them money. His mother maintains a Permanent DMC. By clicking on the “Pay DMC” option, the ATM screen will show Max four slots. In the first slot Max will type in his mother's Permanent DMC. In the second slot Max will type in the exact monetary value to be transferred, or rather to be deposited into his mother's Permanent DMC. To pay for the transferred funds, Max can either feed Egyptian banknotes into the ATM or use his Visa credit card, issued by Bank of Cairo, or any other credit card he has such as MasterCard or American Express. Upon clicking OK, the DMC system will deposit the exact monetary value into Max mother's Permanent DMC. Max's mother in manila can immediately cash out the deposited funds. The other two slots shown on the ATM screen are optional. In the third slot Max can type in his Egyptian mobile phone number and in the fourth slot his mother's Filipino mobile phone number. Upon clicking OK, the DMC system will send Max in Cairo and his mother in Manila an identical message to their mobile phones informing them of the exact amount of money that has been deposited into Max mother's Permanent DMC.

The fund transfer process carried out by Max using an ATM in Cairo to transfer money to his mother living thousands of miles away can also be carried out by him from the comfort of his home in Cairo by using his Egyptian mobile phone by sending a short text message to 666 of the DMC Mobile Phone Center of the local Egyptian Telecom, Mobinil. The short message will include only three short lines. In the first line Max will type in “Pay DMC”, in the second line his mother's Permanent DMC and in the third line the exact monetary value to be deposited into her Permanent DMC. Max's message will be in the below format.

Pay DMC

DAVIDLONDON1959

$200

Max can also add a fourth line to type in his mother's Filipino mobile phone number. If he chooses to include her mobile phone number, the DMC system will send her a message informing her of the amount of money that has been deposited into her Permanent DMC. Max too will receive a copy of the transfer notification. The VMS will empower workers scattered worldwide to purchase airtime coupons from any supermarket, scratch off the opaque protective layer, and type in the code on their mobile phones and send them to 666 of the DMC Mobile Phone Center. As soon as a worker presses the “Send” key on his/her mobile phone the exact money will instantly be deposited into the family member's Permanent DMC.

The convenience and flexibility described above is not limited to Permanent DMC alone. Non-Permanent DMCs too can be maintained and used in this manner, even if they have a balance of few cents. The DMC system can keep a Permanent DMC current for a maximum period of two years, even with a zero balance, to allow customers to use them again after a period of dormancy.

Customers holding and maintaining Permanent DMCs can check their balance by sending a short text message, such as “Balance”, or three digit message such as 121, to 666 of the DMC Mobile Phone Center and receive an instant sms showing their balance. They can also receive instant confirmations of any transaction, whether they were carried out at the local restaurant, buying products and services from the Internet or drawing cash at ATM machines or via other routs as explained previously.

The universality, flexibility and mobility of DMC and DMCT will energize global commerce; merchants, corporations and small firms will be able to increase sales, expand commercial activities and develop new markets. Transactions will become streamlined, fast and reliable.

Like current ATMs, cameras of DMC machines and ATMDMC machines will record cashing out DMC' s and DMCTs and prevent criminal activities, as when someone attempts to illegally cash out a DMC or DMCT, even finger prints can be used for further security of these transactions and eye scans can be used two.

DMCs and DMCTs can also be used to purchase movies from vendors on the Internet. Vendors, such as iTunes or HBO, can adopt and use DMCs and DMCTs as security methods to prevent digital pirates from stealing their intellectual property rights and to stop hackers from pirating their movies illegally.

Customers can use their DMCs to purchase movies on the Internet. After accessing the website of movie vendor, such as iTunes or Amazon, and typing in his/her DMC and NN and the movie (s) he/she wants to purchase, a customer will receive a password via his/her email or mobile phone. Next, the vendor will allow the customer to download a software program, which will allow the customer to watch the movie. Next, the movie will be downloaded, but at this stage the movie is still encrypted and unwatchable. Next, the software program will ask the customer to type in the password. As soon as the password is typed in the software program will decrypt the film and the customer is now ready to watch the movie. This method will put an end to movie piracy and will be widely adopted by movie vendors.

The process of online movie purchase described above is also applicable to purchasing movies and music on DVDs and CDs in shops. Each encrypted CD and DVD sold in shops will come with a unique Identification Number and require a password to activate it. Vendors will dedicate a specific telephone number, say 800-555-4444, to enable customers to decrypt and activate purchased movies and music, as DVDs and CDSs. Vendors will sell their music and movies as encrypted CDs and DVDs respectively. But what does the process entail this time? Let us suppose that Robert has purchased “Love in Rome”, a romantic movie, in his neighborhood mall. The movie is encrypted, and hence unwatchable, when Robert inserts it into his DVD player or PC and tries to watch it. To be able to watch the movie, Robert will scratch the secret code hidden under an opaque protective coating on the DVD box. Upon sending it to 800-555-4444 Robert will receive a vital code on his mobile phone, which will enable the software within the DVD to decrypt the movie. Movies will not be watchable unless the software, which will require a specific password, decrypts them.

In few short years the DMC will be ubiquitous, used in every corner of the world, become a vital part of people's lives and an indispensable component of world economy and global commerce. It will become as popular as the Internet, as vital as mobile phones and people will wonder how we ever lived before the invention of DMCs.

To promote and market the DMC during the initial launch phase social media, such as Facebook and Twitter, can be used to make people all over the world aware that a unique and remarkable phenomenon called DMC has just been unleashed on the world stage and it will change their lives forever.

Two of the most central aspects of the VMS are flexibility and mobility. The VMS will empower people worldwide to buy and transfer DMCT's without being bound to any specific geographical location. The VMS will enable individuals, whether they are walking, driving, traveling on trains or onboard cruise ships to purchase DMC's and send them across the world in a flash. They will be able to do that easily and securely whether they live in small villages, large towns or huge metropolitan cities, and all they need to do that is a mobile phone and a local Telecom.

So how will banks, whether small traditional community banks or trans-national banks cooperate to create the necessary infrastructure to render buying and transferring DMCTs possible? And what sort of components, hardware, software programs, networks, financial arrangements, commercial protocols and inter-banks arrangements are needed to make the DMCT an integral part of our financial lives, an indispensable component of global commerce and a vital piece of our fast modern-day living.

It is important to bear in mind that since the inception of Telecoms and the introduction of ATMs in the 70s of the last century, a strong and constantly evolving relationship has locked together the banking sector with the telecommunication industry. They have become intertwined and inseparable. In the last forty years their cooperation has enriched our lives and enabled us to conduct all sorts of financial transactions easily and securely. Their close cooperation strengthened both industries to such a degree that it is impossible, if not suicidal, to revert to the era predating their close cooperation and active collaboration.

Today, as Telecom subscribers, we have grown accustomed to receiving confirmations of our banking transactions on our mobile phones; our banks sends us instant messages as soon as we draw cash from ATMs, charge our credit cards or buy items and services from the Internet.

Telecom subscribers receive from their banks daily sms informing them of the balance of their checking and saving accounts, not to mention monthly bank statements or reminders of E-statements. All these, and more, services are possible because of the strong, indispensable and evolving relationship between banks and Telecoms.

But are the existing networks, infrastructure, and business relationship between the two sectors sufficient and mature enough to launch the DMCT segment of the VMS. The answer is no it is not. So what do we need to do to make buying and transferring DMCTs possible and common practice worldwide?

Let us suppose Bank of America has decided to get onboard with the VMS and wants to offer its customers the choice to buy and transfer DMCTs, how will it go about it and what will customers have to do to be able to benefit from this service?

Bank of America will be able to offer its customers three choices or three routes to buy DMCTs; either to buy DMCTs online, through its Bank of America website, www.bankofamerica.com, or via customers' mobile phones or via ATMs. Other banks worldwide can also offer these three choices, from small rural banks in India to huge conglomerate banks in industrialized and rich countries, like, Bank of Tokyo or Barclays. Not only giant banks like Bank of America will be able offer the DMCT service, small banks too will be able to offer their customers the exact service offered by big, rich banks.

To be able to offer, execute, track and administer all financial, administrative and technical issues related to selling and cashing DMCTs, Bank of America needs first to deal with many issues and create the right technical, administrative and financial conditions necessary before launching the DMCT. To give a flavor of the complexity and wide ranging financial, administrative and technical issues banks will be required to deal with on daily, hourly and minute-by-minute basis, we need to highlight some of the issues and matters banks, such as Bank of America, will be compelled to deal with. In no way the issues listed in the next paragraph represents a comprehensive, definitive and final list. On the contrary, these are but samples of the myriad of issues that require meticulous, precise and definitive procedures, software programs and mechanisms to be implemented and executed before launching the DMCT program. They are listed here to convey the complex and inter-connected nature and relationship between banks, Telecoms, Internet, and general commerce.

Some of these issues are related to customer's data, inter-banks protocols whether local, regional or international banks, financial, business, profits sharing and technical issues with Telecoms, vital service and profit sharing agreements with financial service corporations such as money exchange institutions like Western Union, business and financial agreements with credit card service providers like American Express, Visa and MasterCard and financial and business agreements with online vendors such as iTunes, financial service providers like PayPal and ISIS or with social networks sites such as Facebook.

Before launching and executing the program to sell and cash out DMCT's, Bank of America will be required to deal with all above-mentioned matters and other relates matters. Luckily Bank of America does not need to start from scratch and re-invent the wheel. Its existing technical, administrative and financial infrastructure is highly developed and vastly mature and the bank possesses almost all of what is needed to launch the DMCT program. What is needed is just another additional technical layer and an administrative branch.

To enable its customers buy and transfer DMCTs Bank of America will establish three routes, or three mechanisms, to achieve that; either via its website, ATMs or through customers' mobile phones.

Let us consider the first option. Currently Bank of America customers, can transfer and receive funds using the bank's website. After opening a checking and/or saving account, customers are able to access their accounts by establishing user ID and password. The banks wide ranging services allow its customers to carry out a variety of financial actions, including purchases using Bank of America-issued Visa or MasterCard, debit cards and cash cards.

When the VMS is up and running, Bank of America customers will be able to click on DMCT tab on its website to purchase the amount they want. They can pay for the DMCT either from their checking or saving accounts or charge it to their credit cards. The customer will fill in the relevant slots on the website which will include his/her mobile number, his email address, mobile number and email address of intended recipient, “Buy DMCT, and desired monetary value. Customer can buy DMC from websites too.

The second option is through customers' mobile phone numbers. To execute the second option, Bank of America will be required to work closely with one or multiple local and regional Telecoms. In the mid-Atlantic region for instance, Bank of America may deal with ATT. A dedicated customer number, let us say 666, will be set aside by ATT to receive purchase requests of DMCTs offered by Bank of America.

A powerful software program is needed to administer, execute and track all aspects of DMCT transactions at every stage of this highly sophisticated system. Now, let us go back to Tom, who has checking and saving accounts as well as Visa credit card with Bank of America in his hometown Baltimore. So what happens when Tom sends his request to buy a DMCT for his mother in London, UK? When Tom sends his request to 666, a dedicated number administered by ATT to receive purchase requests of DMCTs offered by Bank of America, ATT's server will forward the request to Bank America's DMC System Mobile Center server. The DMC System server will instantly initiate a series of highly defined systematic actions to execute Tom's request to purchase a DMCT.

Upon receiving Tom's message, Bank of America's DMC system will instantly create a specific portfolio for Tom and save it in a specific location on the memory of the DMC system server. For the sake of clarity and simplicity we shall call that portfolio “Tom's Portfolio”. Tom's Portfolio will contain the following details:

DMCT

Secret Number (SN)

Authentication Numbers (ANs)

Net Numbers (NNs) (No of NNs will depend on DMCT value; average is 30-50)

Original monetary value of purchased DMCT

Date of Purchase of DMCT

Tom's US mobile phone number,

Tom mother's British mobile phone number p An association linking Tom's American mobile phone number with his mother's British mobile phone number.

As soon as the DMC system creates “Tom's Portfolio” it will immediately encrypt and save it on Bank of America's DMC system's server. It is important to highlight here an important point to serve as a future reminder. When sending the encrypted DMCT and corresponding codes, data and information of “Tom's Portfolio”, the DMC system server of Bank of America will not send along the AN. The AN will be kept on the DMC system's server as a built-in encrypted checker to determine authenticity, propriety of data and to thwart hacking and illegal attempts to cash out DMCTs by hackers and thieves.

So what happens next, after creating, encrypting and saving “Tom's Portfolio” on the DMC system server of Bank of America? How will the DMC system send the short text message to Tom and his mother? Will the DMC system send the same message to Tom and his mother directly? The answer is no. The DMC system will send the encrypted DMCT codes to ATT's server, which will in turn send the encrypted codes as an identical short text message to both mobile phone numbers, Tom and his mother's. A special Bank of America application already installed on Tom's and his mother's mobile phone sets will decrypt the received DMCT messages containing all the vital codes. This will enable Tom and his mother to use the same DMCT, if they wish to draw cash from any ATM in the US, UK, or anywhere else in the world.

When the mother receives the DMCT message on her British mobile phone, she can go to any ATM in London, or any other British city, to cash out the DMCT. As soon as she types in the DCMT, the corresponding SN and the desired amount of cash in the appropriate slots on the ATM screen and clicks OK, a message will appear on the ATM screen telling her that a short message containing the AN has been sent to her mobile phone and that she should type it in the received AN in the appropriate slot on the ATM screen. Upon typing in the AN in the appropriate slot on the ATM screen and clicking OK, the British ATM will dispense the requested cash.

This process involves the server of Barclays Bank encrypting and sending the codes used by Tom's mother to the DMC system of Bank of America via a secure Internet line. The last server will check the information and upon establishing its authenticity it will send the AN already saved on the server's memory as part of “Tom's Portfolio” it sends it to Tom's mother mobile phone via the standard way of sending messages to mobile phones, when she enters the last piece of the puzzle, i.e. the AN and clicks OK, Barclays Bank's ATM will send the AN to Barclays Bank's server which in turn will send the AN to the DMC system of Bank of America via a secure Internet line. Upon verification the authenticity of the AN, an OK will be sent by Bank of America to Barclays Bank. Barclays Bank's server will relay the OK to the ATM in London, the one Tom's mother is using to draw cash from, to authorize and dispense the desired cash.

One of the most important issues related to the use, success and proliferation of DMCs globally, which will not only require careful consideration but also the establishment of the necessary mechanism to ensure its smooth execution is the question of global currency exchange rate. Since different countries use different currencies, sending a DMC purchased in one country in a specific currency to another country using different currency will require the existence of an efficient and robust currency exchange mechanism to enable the recipient to cash out the received DMC.

When John purchases a DMC worth $500 in the New York City and sends it to his sister Carol in Chicago, she will not encounter currency exchange rate problem to cash her DMC since the DMC was transmitted and received in US dollar and ATM, DMC machine and ATMDMC machine used to cash out the DMC in the US will dispense the cash in US banknotes. In a nutshell when DMCs are purchased and cashed out in the same country, customers will not encounter currency exchange problems.

But when a DMC is purchased in one country, say the US, and transmitted to another country, for instance Japan, the recipient will face a currency exchange rate problem, because the Japanese ATM will issue the monetary value of the DMC in Japanese Yen. Thus, the VMS has to resolve the currency exchange rate issue in an effective and comprehensive way.

To resolve the currency exchange issue let us remember that the global banking system over the last two hundred years has not only developed a sophisticated and efficient global currency exchange system but this system has also a comprehensive governing system of rules, regulations, laws, bi-lateral agreements and global networks to administer and manage the transfer, tracking, and execution of millions of transactions every day in all kind of currencies.

The global banking system is daily responsible for securely and instantly transferring trillions-worth of dollars covering more than 200 various currencies.

This same mature global banking system will be instrumental in adopting, supporting and executing transactions of the Virtual Money System. The Virtual Money System will not start from scratch and be forced to re-invent the wheel. The Virtual Money System will piggybank on the back of the existing global banking system and use all its networks, banks, ATMs, currency exchange mechanisms and fees systems.

For the VMS to go global, banks, especially multi-national banks such as Citi, Barclays, Bank of America and Chase, must adopt and use the VMS in parallel with the existing global banking system; they should support it and make it available to their customers. This will give the VMS a strong boost to develop, accelerate and become an indispensable financial system to world economy and global commerce. These international banks will use, adopt and modify the current existing currency exchange rate system currently used for transferring currencies worldwide to suit the needs, nature, system, networks and mechanisms used and adopted by the VMS.

Can the DMC Mobile Phone Center be used to send money abroad? The answer is absolutely yes. Imagine Tom, who lives in Chicago, USA, and he wants to send his mother who lives in Tokyo, Japan, $1,000. To initiate the fund transfer, Tom needs to send a short text message, henceforth sms for short, via his mobile phone to 666, a dedicated number of the DMC Mobile Phone Center, a center created by a specific bank to sell DMCTs. In our imagined story we shall assume that the bank in question is Bank of America, one of the largest banks in the US and the world.

But before sending his sms Tom has to decide whether he wants to receive an identical copy of the sms and email message, which will be sent by the DMC Mobile Phone Center to his mother's Japanese mobile phone and her email address. If Tom decides that he needs to receive a copy of the sms and email message to keep track of his financial records, then the DMC Mobile Phone Center will send an identical sms and email message to both mobile phones and email addresses. The sms and email message will not only represent a solid confirmation that the DMCT transaction was successfully carried out but the sms and email message will contain the vital codes of the purchased DMCT. These all-important codes enable the recipients, Tom and his mother, to cash out the DMCT at any time they want.

Almost in every imaginable situation, a customer purchasing a DMCT for someone else will opt to receive a copy of the identical sms and email message as a solid proof that the transaction was properly executed as well as to have the vital codes of the purchased DMC Via Telephone on his/her mobile phone and email inbox , in case the intended recipient, for whom the DMCT was purchased, losses or inadvertently erases his/her sms and email message.

The DMC system of Bank of America will give Tom many options to decide what to receive, how to receive and the number of confirmations of the DMCT purchase. To demonstrate the wide range of choices available to Tom, it is reasonable to assume that both Tom and his mother in addition to their mobile phones will also have email addresses, as two individuals living in two highly advanced countries. We can immediately realize the multiple numbers of possible combinations. Tom may opt to choose anyone of the possibilities listed below:

Tom and his mother will receive sms and email messages
Tom and his mother will receive only sms and no email messages
Tom will receive an sms but his mother will receive an sms and email message
Tom will receive an sms but his mother will receive an email message
Tom will not receive an sms and email message but his mother will receive an sms and an email message
Tom will not receive an email but his mother receive only an sms
Tom will not receive an email and his will receive an email message only

While the listing above seem a theoretical mental exercise to demonstrate all possible available options, in reality we can safely assume that any DMCT customer will opt to have the sms and email message sent to him/her as well as to the individual for whom he/she is buying the DMCT. But just because Tom and his mother live in two highly advanced countries does not mean people living in less developed countries cannot use the VMS. Having personal mobile phones and email address has become common and ubiquitous worldwide. And in rare situations when a direct ownership of a mobile phone number and email address is not possible then access to them through relatives and friend is more than probable.

Below we shall show two formats of the message Tom can send, reflecting two possible situations; whether Tom wants to receive an sms and email message or not from the DMC Mobile Phone Center as a confirmation of the DMCT purchase.

In the first situation Tom decides he wants to receive an sms and email message from the DMC Mobile Phone Center. So how will Tom's sms, which he is required to send to 666 of the DMC Mobile Phone Center, look like and what will it include? Tom's message will include 6 short lines. In the first line Tom will write his US mobile phone number, in the second his email address, in the third his mother's British mobile phone number, in the fourth her email address, in the fifth “Buy DMCT” and in the sixth the monetary value he wants to buy for his mother, in this case $1,000.

7036665555

TomBush@aol.com

0044799223455

NormaBush@aol.com

Buy DMCT

$1,000

It is very clear from Tom's message above that he has the choice to eliminate only three lines: his mobile phone number, his email address and his mother's email address. Tom cannot, however, under any circumstance eliminate his mother's British mobile phone number. In theory Tom can justify his choice to eliminate the three lines mentioned above by saying “Bank of America is a great bank and will execute my transaction professionally, therefore I do not need to receive an email or a short message on my mobile phone to confirm the transaction and my mother is too busy to read her email messages while she is on vacation”. We have previously demonstrated the critical function played by the AN in cashing out a DMCT. In fact if Tom's mother does not receive the all-important DMCT message on her mobile phone device while vacationing in London it is impossible for her to cash out her DMCT. In a nutshell, no DMCT message on the recipient's mobile phone, no possibility whatsoever to cash out received DMCT.

Since 99.9% if not 100% of customers buying DMCTs for some else will want to get a confirmation sent to their mobile phones, we shall assume that Tom too wants to receive an sms as well as an email message from the DMC Mobile Phone Center on his mobile phone and email address. The received message will contain all the vital codes of the purchased DMCT to enable a recipient to cash out the DMCT at any time.

So how will Tom's message in the second situation look like if he does not want to receive neither a message on his American mobile phone nor an email message but instead he wants his mother to receive both formats of notifications? In the first line Tom will write his mother's British mobile phone number, in the second his mother's email address, in the third “Buy DMCT”, and in the fourth the monetary value Tom wants to send his mother, $1,000, as stated before.

0044799223455

LaraBush@aol.com

Buy DMCT

$1,000

To cash out a DMCT at an ATM, a customer shall need the DMCT, SN and the AN to be able to get cash from an ATM. But to cash out a DMC, a customer will not need the NN, only the SN is needed.

The real owner of the DMC can draw cash from the ATM machine by using the DMC and one of the NNs, but after using this particular NN it will become obsolete and not usable again. So in this option the SN is not used on the ATM machine, but the NN is used.

Having covered the VMS in detail, highlighted its main features and realized its great future potential, at this stage we need to answer an important question. How does the VMS stack up to the competition? Put in another word, what makes VMS different, better or more likely to succeed in creating a comprehensive, practical, and global financial networked system where others failed or simply managed to achieve a very modest success?

Currently the world is replete with ways and networks to send money locally, regionally or globally. Banks, money exchanges and financial institutions provide these schemes.

A brief summary is necessary to show why the VMS will be completely different and light years away from the nearest competitor.

Currently when people want to send money to friends or relatives in the next city, neighboring countries, or another continent, the choices available to them are varied but limited. Some will use their banks, others will utilize money exchanges, some will resort to specific networks or financial arrangements while others will benefit from limited, specific schemes established between two countries to send and receive money.

Let us consider two ways and start with banks. To be able to receive funds transferred by banks the recipient has to have a bank account, a requirement more than two billion people worldwide cannot fulfill. Vast number of poor, underprivileged people as well as people with limited incomes living in villages, rural areas and small towns and cities have no bank accounts, either because they do not qualify, disinterested, or incapable or unwilling to pay the monthly bank account maintenance charges. While banks offer people a convenient way to send and receive money, the cost of sending small amount can be quite prohibitive, especially if it involves covering long travel distance to visit the bank if the bank does permit its customers to send and receive funds using its website. Some banks permit their customers to send and receive funds to each other instantly, but only after they sign up for the program and deposit the funds into the e-money transfer scheme. But only those who have signed up for the program can use it, thus we can immediately see its limitation.

Using money exchange institutions offer customers another channel to wire funds.

While quite convenient and charge reasonable fees, money exchanges are not universally available to people everywhere. And just as banks represent one way to transfer monies, the fact that money exchanges are not open twenty four hours a day seven days a week and customers have to be physically present on the premises to send and receive funds during working hours, not to mention no service during weekends, one can immediately appreciate the restrictions and limitations of money exchanges.

Compare the limitations and inconveniences inherent in banks and money exchanges with the flexibility, convenience and universality of the VMS and you'll immediately see the superior nature of the VMS. Previously we've demonstrated several important and attractive features of this revolutionary scheme. Let us briefly touch upon these features.

First let us remember the most important feature of the VMS, universality. People worldwide will be able to send money instantly to any individual in the world and receive codes that be converted to cash within minutes. All that is necessary to achieve that is for the sender and recipient to have mobile phones and a local Telecoms. From the convenience of their homes, restaurants, clubs, while shopping in local supermarkets, or sun bathing on-board luxury cruise ships, customers will be able to send funds right across the world simply by sending short text message to local Telecom numbers.

Versatility is another important feature of the VMS. Customers will be able to use DMCs as they would use cash. Upon receiving DMCs Customers will be able to either cash them either fully or partially at a local ATM or re-transfer the entire monetary value of the DMC to a third party, or part to it, from the comfort of their homes.

Portability is another great feature of the VMS. A customer can easily, securely and conveniently generate a DMC of a substantial value, for example $100,000, and have the choice to decide how to carry this large sum; either as a small magnetic card the size of a standard credit card and slip into his/her pocket, or as two easy-to-remember codes contained in an ATM printout or as two easy-to remember codes created by the customer and simply committed to memory; imagine a customer carrying $100,000 in his head, walking passed passport control officers at airports, crossing borders and flying around the world with the ability to get cash in any country using local ATMs or walking into any bank in the world, reveal the two codes to a bank official and get the cash.

But perhaps the most striking and important feature of the VMS is its availability around the clock. A customer can use the VMS day and night, seven days a week. Customers will not be bound by working hours of banks and money exchanges. They can send and receive funds during weekends, working days, national holidays, at midnight, at 3 pm, or at midday; in a nutshell at any one moment during the day throughout the year, but more importantly a customer will not ever be required to step into banks or any financial institution or money exchange to send funds across the world.

In light of the previous comparison, can we describe in one short line the VMS and its powerful arm the DMC? The answer is simple, yes we can. The VMS is global, portable, mobile, convenient, versatile, user-friendly, and instantaneous. It will take the world by a storm.

What is claimed is:

1. A Digital Money Code (DMC) system comprising computerized systems, software programs and data storage systems capable of creating, selling and executing DMC transactions and empowering customers to convert their cash to DMCs and cash out their DMCs at different locations.

2. The Digital Money Code system of claim 1, wherein the system further enables customers to send DMCs to other people anywhere in the world and to cash out purchased DMCs at any time they want.

3. The Digital Money Code system of claim 1, further comprising Automated Teller Machines (ATMs) capable of selling DMCs to customers and cashing out purchased DMCs.

4. The Digital Money Code system of claim 1, further comprising DMC machines capable of selling DMCs to customers and cash out purchased DMCs.

5. The Digital Money Code system of claim 1, further comprising ATMDMC machines capable of selling DMCs to customers and cash out purchased DMCs.

6. The Digital Money Code system of claim 1, further comprising coffee machines and other machines capable of selling coffee and other items to customers via DMCs.

7. The Digital Money Code system of claim 1, further comprising Telecoms capable of selling DMCs to customers and cash out purchased DMCs via ATMs.

8. The Digital Money Code system of claim 1, further comprising Internet systems and websites capable of selling DMCs to customers and cash out purchased DMCs via ATMs.

9. The Digital Money Code system of claim 1, further comprising Internet systems and websites enabling customers with DMCs to buy goods and services from the Internet.

10. A Virtual System comprising DMC, Secret Number, Authentication Numbers and Net Numbers; where the Virtual System enables customers to convert cash to DMC and covert DMC to cash via the DMC system.

11. A Virtual Money System comprising a DMC system and a Virtual System, where the Virtual Money System is capable of creating, selling and executing DMC transactions and empowering customers to convert their cash to DMCs and cash out their DMCs at different locations.

12. The Virtual Money System of claim 11, wherein the Virtual Money System further enables people to send DMCs to other individuals anywhere in the world and to cash out purchased DMCs at any time they want.

13. The Virtual Money System of claim 11, further comprising ATMs capable of selling DMCs to customers and cash out purchased DMCs.

14. The Virtual Money System of claim 11, further comprising DMC machines capable of selling DMCs to customers and cash out purchased DMCs.

15. The Virtual Money System of claim 11, further comprising ATMDMC machines capable of selling DMCs to customers and cash out purchased DMCs.

16. The Virtual Money System of claim 11, further comprising coffee machines and other machines capable of selling coffee and other items to customers via DMCs.

17. The Virtual Money System of claim 11, further comprising Telecoms capable of selling DMCs to customers and cash out purchased DMCs via ATMs.

18. The Virtual Money System of claim 11, further comprising Internet systems and websites capable of selling DMCs to customers and cash out purchased DMCs via ATMs.

19. The Virtual Money System of claim 11, further comprising Internet systems and websites enabling customers with DMCs to buy goods and services from the Internet.
